(19) United States
(12) Patent Application Publication
(10) Pub. No.: US 2025/0385402 A1
(43) Pub. Date: Dec. 18, 2025

(54) BATTERY CELL TAB TERMINAL CONFIGURATION

(71) Applicant: Ford Global Technologies, LLC, Dearborn, MI (US)

(72) Inventors: Yongcai Wang, Ann Arbor, MI (US); Chi Paik, Grosse Ile, MI (US); Brian Utley, Canton, MI (US); Kyungjin Park, Northville, MI (US); Daewon Han, New Hudson, MI (US)

(21) Appl. No.: 18/741,948

(22) Filed: Jun. 13, 2024

(51) Int. Cl. H01M 50/555; H01M 50/249; H01M 50/505; H01M 50/548; H01M 50/562; H01M 50/566

(52) U.S. Cl. CPC H01M 50/555; H01M 50/249; H01M 50/505; H01M 50/548; H01M 50/562; H01M 50/566

(57) ABSTRACT

A battery pack may include a busbar including a slot. A battery pack may include a battery cell including a housing and a tab terminal extending from the housing in a first direction, wherein the tab terminal includes a plurality of fingers spaced-apart from one another in a second direction perpendicular to the first direction, and wherein each of the plurality of fingers is in direct contact with the busbar.

### TECHNICAL FIELD

This disclosure relates generally to electrified vehicles, and more specifically relates to a tab terminal configuration for battery cells.

### BACKGROUND

A high voltage traction battery pack typically powers the electric machines and other electrical loads of an electrified vehicle. The traction battery pack includes a plurality of battery cells. The battery cells must be reliably connected to one another in order to provide the voltage and power levels necessary for achieving vehicle propulsion.

### SUMMARY

In some aspects, the techniques described herein relate to a battery pack, including: a busbar including a slot; and a battery cell including a housing and a tab terminal extending from the housing in a first direction, wherein the tab terminal includes a plurality of fingers spaced-apart from one another in a second direction perpendicular to the first direction, and wherein each of the plurality of fingers is in direct contact with the busbar.

In some aspects, the techniques described herein relate to a battery pack, wherein: the tab terminal includes a base section adjacent the housing, and each of the plurality of fingers projects from the base section to a free end opposite the housing.

In some aspects, the techniques described herein relate to a battery pack, wherein the base section is uninterrupted by gaps between a first edge of the tab terminal and a second edge of the tab terminal opposite the first edge.

In some aspects, the techniques described herein relate to a battery pack, wherein: an edge of one of the plurality of fingers is coextensive with the first edge of the tab terminal, and an edge of another of the plurality of fingers is coextensive with the second edge of the tab terminal.

In some aspects, the techniques described herein relate to a battery pack, wherein free ends of each of the fingers are coextensive with a free end of the tab terminal.

In some aspects, the techniques described herein relate to a battery pack, wherein: each of the plurality of fingers includes a first straight section between the base section and a bend, and each of the plurality of fingers includes a second straight section between the bend and the free end.

In some aspects, the techniques described herein relate to a battery pack, wherein the bends of each of the plurality of fingers are at a common distance from the base section amongst each of the plurality of fingers.

In some aspects, the techniques described herein relate to a battery, wherein each of the plurality of fingers is configured such that the first straight section is substantially equal in length to the second straight section.

In some aspects, the techniques described herein relate to a battery pack, wherein each of the plurality of fingers is configured such that the second straight section is substantially parallel with a side of the busbar opposite the housing.

In some aspects, the techniques described herein relate to a battery pack, wherein each of the plurality of fingers is secured to busbar via a weld between the side of the busbar opposite the housing and the second straight section of each of the plurality of fingers.

In some aspects, the techniques described herein relate to a battery pack, wherein each of the plurality of fingers are spaced-apart from an adjacent one of the plurality of fingers by a gap.

In some aspects, the techniques described herein relate to a battery pack, wherein each of the gaps are of substantial equal width.

In some aspects, the techniques described herein relate to a battery pack, wherein each of the plurality of fingers projects through the slot.

In some aspects, the techniques described herein relate to a battery pack, wherein each of the plurality of fingers are formed by laser cutting the tab terminal.

In some aspects, the techniques described herein relate to a battery pack, wherein the tab terminal is a first tab terminal extending from the housing, and wherein the battery pack further includes a second tab terminal extending from the housing in a third direction opposite the first direction, wherein the second tab terminal includes a plurality of fingers spaced-apart from one another in the second direction, and wherein each of the plurality of fingers is in direct contact with another busbar.

In some aspects, the techniques described herein relate to a battery pack, wherein the tab first tab terminal is made of one of copper and aluminum, and the second tab terminal is made of the other of copper or aluminum.

In some aspects, the techniques described herein relate to a method, including: electrically connecting a tab terminal of a battery cell to a busbar by inserting the tab terminal through a slot in the busbar, bending each of a plurality of fingers of the tab terminal, and securing each of the fingers to the busbar.

In some aspects, the techniques described herein relate to a method, wherein the tab terminal extends from a housing of the battery cell in a first direction, and wherein the plurality of fingers are spaced-apart from one another in a second direction perpendicular to the first direction.

In some aspects, the techniques described herein relate to a method, wherein: the tab terminal includes a base section adjacent a housing of the battery cell, each of the plurality of fingers projects from the base section to a free end opposite the housing, each of the plurality of fingers includes a first straight section between the base section and a bend, and each of the plurality of fingers includes a second straight section between the bend and the free end.

In some aspects, the techniques described herein relate to a method, wherein: each of the plurality of fingers is configured such that the second straight section is substantially parallel with a side of the busbar opposite the housing, and each of the plurality of fingers is secured to the busbar via a weld between the side of the busbar opposite the housing and the second straight section of each of the plurality of fingers.

### BRIEF DESCRIPTION OF THE DRAWINGS

FIG. 1 schematically illustrates an electrified vehicle.

FIG. 2 is a perspective view of a battery pack for an electrified vehicle.

FIG. 3 is a cross-sectional view of the battery pack of FIG. 2.

FIG. 4 illustrates a battery cell of a battery array of a battery pack.

FIG. 5 is a close-up view of one of the tab terminals in an unbent state.

FIG. 6 is a perspective view illustrating the tab terminal in a bent state and secured to a busbar.

FIG. 7 is a top view of a portion of the tab terminal in a bent state.

FIG. 8 is a perspective view of the portion of the tab terminal in a bent state.

FIG. 9 is a top view of the portion of the tab terminal in a bent state and secured to a busbar.

### DETAILED DESCRIPTION

This disclosure relates generally to electrified vehicles, and more specifically relates to a tab terminal configuration for battery cells. A corresponding method is also disclosed. The tab terminal of this disclosure includes a plurality of spaced-apart fingers. The fingers are bent to facilitate attachment of the fingers to a busbar. The individual fingers can be bent by applying a lesser force to the fingers, compared to a force required to bend a tab terminal without fingers. Therefore, an amount of force transferred to a housing of the battery cell during a tab terminal bending process is reduced. These and other benefits will be appreciated from the following description.

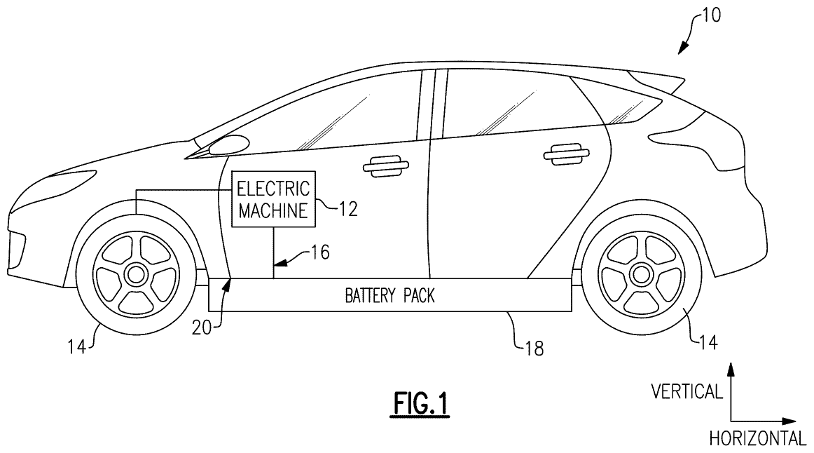

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

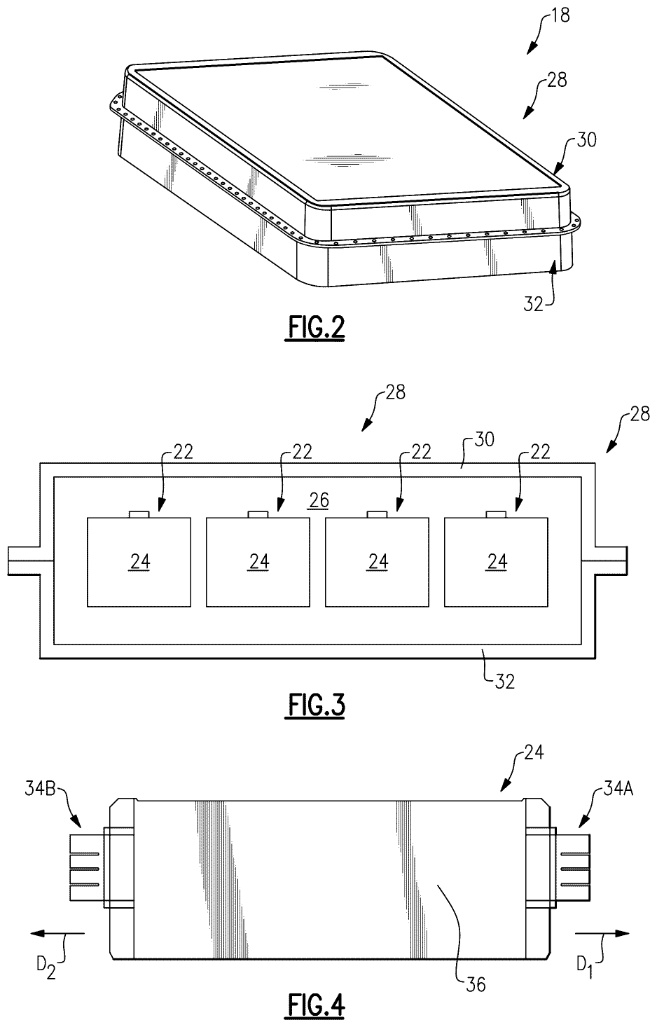

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total number of battery arrays 22 and battery cells 24 provided within the traction battery pack 18 is not intended to limit this disclosure.

In an embodiment, the battery cells 24 of each battery array 22 are pouch style, lithium-ion cells. However, battery cells having other geometries (cylindrical, prismatic, etc.), other chemistries (nickel-metal hydride, lead-acid, etc.), or both could alternatively be utilized within the scope of this disclosure. That said, this disclosure has particular benefits in the context of pouch style cells.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

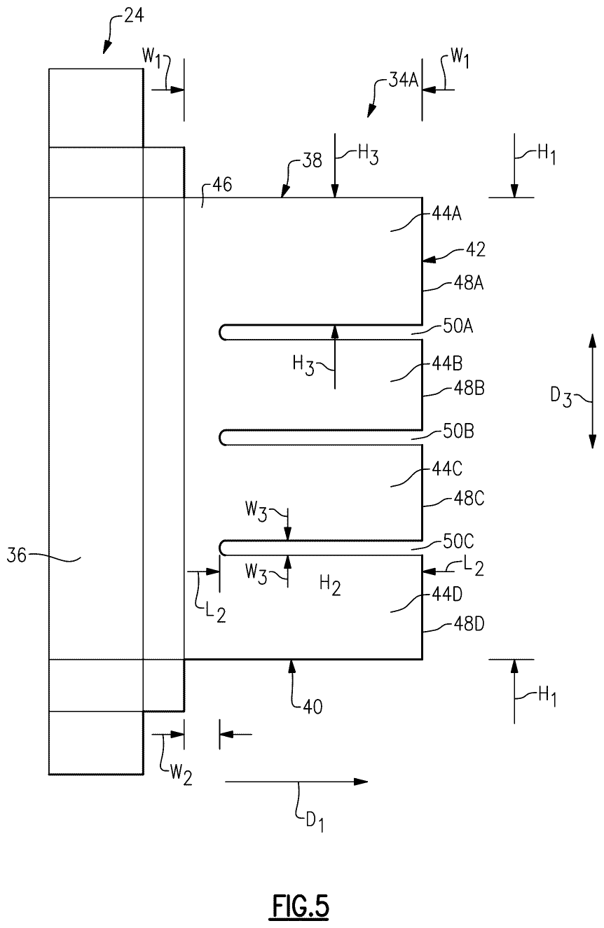

FIG. 4 illustrates one of the battery cells 24 that can be provided within the traction battery pack 18. Each battery cell 24 may include a housing 36 (i.e., a “pouch”) and a pair of tab terminals 34A, 34B (sometimes referred to as “tabs”) that project outwardly from the housing 36. In an embodiment, each battery cell 24 includes two tab terminals 34A, 34B, with one tab terminal 34A, 34B protruding outwardly at each opposing side of the housing 36. Specifically, tab terminal 34A projects outwardly from housing 36 in a first direction D1, and the tab terminal 34B projects outwardly from the housing 36 in a second direction D2 opposite the first direction D1.

In one example, the tab terminal 34A is made of one of copper and aluminum, and the second tab terminal 34B is made of the other of copper and aluminum. In one particular example, the tab terminal 34A, 34B made of aluminum is the positive tab terminal of the battery cell 24, and the tab terminal 34A, 34B made of copper is the negative tab terminal of the battery cell 24.

In some implementations, the housing 36 is a multi-layered structure including an aluminum film layer and a polymer layer. However, other housing configurations are also contemplated within the scope of this disclosure.

The tab terminals 34A, 34B of the battery cells 24 of each battery array 22 must be reliably connected to one another in order to provide the voltage and power levels necessary for achieving vehicle propulsion. Busbars are sometimes used for making such a connection. As will be discussed below, the tab terminals 34A, 34B are bent to facilitate attachment of the tab terminals 34A, 34B to a busbar. This disclosure reduces an amount of force that is transferred to the housing 36 as a result of bending of the tab terminals 34A, 34B.

With reference to FIG. 5, the tab terminal 34A will now be described in more detail. FIG. 5 illustrates the tab terminal 34A in an unbent state. It should be understood that tab terminal 34B is configured substantially similar to the tab terminal 34A, reflected about a centerline of the battery cell 24. The tab terminal 34A is generally bound by a first edge 38 and a second edge 40 opposite the first edge 38. With respect to the configuration of FIG. 5, the first edge 38 is an upper edge, and the second edge 40 is a lower edge. The tab terminal 34A exhibits a height H1 between the first edge 38 and the second edge 40. The tab terminal 34A exhibits a width W1 between the housing 36 and a free end 42 of the tab terminal 34A.

The tab terminal 34A further includes a plurality of fingers 44A-44D spaced-apart from one another in a third direction D3, which is perpendicular to the first direction D1 and parallel to the dimension of the height H1. In this example, there are four fingers 44A-44D. While four fingers 44A-44D are shown, this disclosure extends to tab terminals with at least two fingers.

As shown in FIG. 5, the tab terminal 34A includes a base section 46 adjacent the housing. The base section 46 exhibits a width W2 less than width W1. The base section 46 is free of, and uninterrupted by, any gaps or openings, when moving along the base section 46 in the third direction D3 between first edge 38 and second edge 40.

The fingers 44A-44D project from the base section 46 to respective free ends 48A-48D thereof. Free ends 48A-48D of the fingers 44A-44D collectively provide the free end 42 of the terminal. In this regard, the free ends 48A-48D are coextensive with the free end 42.

Each of the plurality of fingers 44A-44D are spaced-apart from an adjacent one of the plurality of fingers 44A-44D by a gap 50A-50C. Each gap 50A-50C extends from the base section 46 to the free end 42 in the first direction D1 and exhibits a length L2. The fingers 44A-44D also exhibit the length L2. The gaps 50A-50C may be formed by laser cutting or another manufacturing technique. The gaps 50A-50C exhibit a width W3. The dimensions of the gaps 50A-50C are substantially the same.

The fingers 44A-44D exhibit a common height H3. The fingers 44A-44D exhibit substantially uniform dimensions such that each finger 44A-44D is sized and shaped substantially the same as the other fingers 44A-44D. In the configuration of FIG. 5, an upper edge of the finger 44A is coextensive with first edge 38, and a lower edge of finger 44D is coextensive with second edge 40. The remainder of the upper and lower edges of the fingers 44A-44D are provided by the gaps 50A-50C.

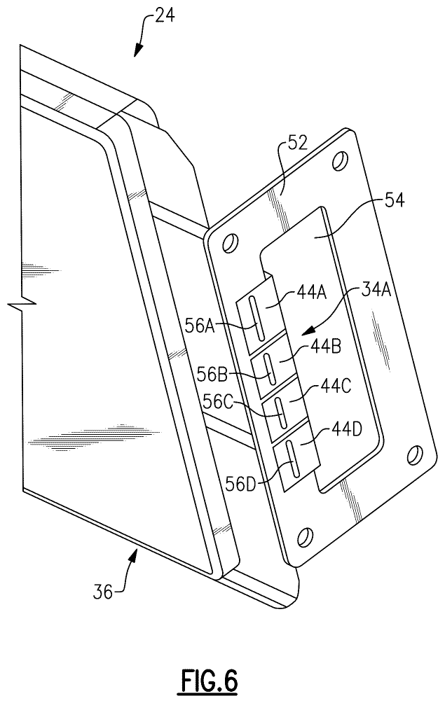

FIG. 6 illustrates the tab terminal 34A relative to a busbar 52. The busbar 52 is configured to transfer current to a neighboring battery cell or to another battery array, for example. As shown in FIG. 6, each of the fingers 44A-44D is inserted into, and passes through, a slot 54 in the busbar 52 and is in direct contact with the busbar 52. In this example, each of the fingers 44A-44D is bent so as to facilitate a connection with the busbar 52. Each of the fingers 44A-44D is secured to the busbar 52 by laser welding, in this example. Laser welds 56A-56D are represented in FIG. 6.

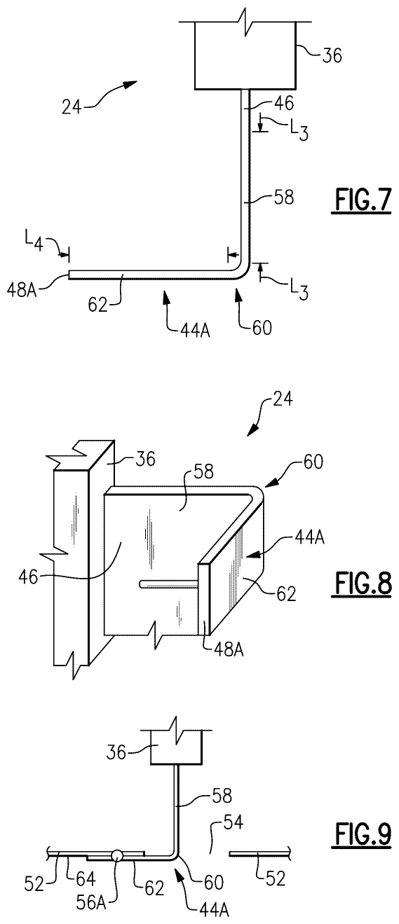

FIGS. 7-8 are representative of a configuration of one of the fingers 44A after undergoing a bending process. It should be understood that each of the fingers 44A-44D is configured substantially similarly following the bending process. Further, in an example bending process, each of the fingers 44A-44D is bent individually. In this manner, only a fraction of the force is required to bend each of the fingers 44A-44D as compared to the force required to bend a similarly-sized tab terminal without fingers (i.e., a tab terminal sized and shaped similar to tab terminal 34A, but without the fingers 44A-44D and gaps 50A-50C). In a particular example, each of the fingers 44A-44D can be bent by applying about 25% of the force that would be required to bend a similarly-sized tab terminal without fingers. The fingers 44A-44D can be bent using a wiper configured to slide into contact with each of the fingers 44A-44D individually. The wiper could include a stepped arrangement such that the wiper only bends one of the fingers 44A-44D at a time.

As shown in FIG. 7, the finger 44A includes a first straight section 58 between the base section 46 and a bend 60. The finger 44A may be plastically deformed at the bend 60. In this disclosure, the bend 60 is not provided in the base section 46, but is instead formed at some point along the length of the finger 44A. The finger 44A further includes a second straight section 62 between the bend 60 and the free end 48A. The bend 60 provides a substantially 90° turn between the first and second straight sections 58, 62. While the first and second straight sections 58, 62 are referred to as “straight,” in practice they may be substantially straight.

In this example, the first straight section 58 exhibits a length L3 measured between the base section 46 and the bend 60, and the second straight section 62 exhibits a length LA measured between the bend 60 and the free end 48A. Each of the fingers 44A-44D exhibits the same lengths L3, L4 for their respective first and second straight sections 58, 62 such that the bends 60 of each of the fingers 44A-44D are aligned relative to the first direction D1, and in particular are the bends 60 of each of the fingers 44A-44D are at a common distance from the base section 46. Lengths L3, L4 are substantially equal in one example.

The bent configuration of the fingers 44A-44D facilitates attachment to the busbar 52. As shown in FIG. 9, finger 44A projects through the slot 54 in the busbar 52, and more particularly the first straight section 58 projects through the slot 54. The second straight section 62 is substantially parallel with a side 64 of the busbar 52 opposite the housing 36. As such, the second straight section 62 can be brought into direct contact with the side 64 and affixed to the side 64 via a laser weld 56A, for example.

It should be understood that terms such as “about” and “substantially” are not intended to be boundaryless terms, and should be interpreted consistent with the way one skilled in the art would interpret those terms. Directional terms such as “above,” “upper,” “below,” “bottom,” etc., are used with reference to the arrangement of the corresponding components in the drawings and are not intended to otherwise be limiting.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
a busbar including a slot; and
a battery cell including a housing and a tab terminal extending from the housing in a first direction, wherein the tab terminal includes a plurality of fingers spaced-apart from one another in a second direction perpendicular to the first direction, and wherein each of the plurality of fingers is in direct contact with the busbar.

2. The battery pack as recited in claim 1, wherein:
the tab terminal includes a base section adjacent the housing, and
each of the plurality of fingers projects from the base section to a free end opposite the housing.

3. The battery pack as recited in claim 2, wherein the base section is uninterrupted by gaps between a first edge of the tab terminal and a second edge of the tab terminal opposite the first edge.

4. The battery pack as recited in claim 3, wherein:
an edge of one of the plurality of fingers is coextensive with the first edge of the tab terminal, and
an edge of another of the plurality of fingers is coextensive with the second edge of the tab terminal.

5. The battery pack as recited in claim 3, wherein free ends of each of the fingers are coextensive with a free end of the tab terminal.

6. The battery pack as recited in claim 2, wherein:
each of the plurality of fingers includes a first straight section between the base section and a bend, and
each of the plurality of fingers includes a second straight section between the bend and the free end.

7. The battery pack as recited in claim 6, wherein the bends of each of the plurality of fingers are at a common distance from the base section amongst each of the plurality of fingers.

8. The battery as recited in claim 6, wherein each of the plurality of fingers is configured such that the first straight section is substantially equal in length to the second straight section.

9. The battery pack as recited in claim 6, wherein each of the plurality of fingers is configured such that the second straight section is substantially parallel with a side of the busbar opposite the housing.

10. The battery pack as recited in claim 9, wherein each of the plurality of fingers is secured to busbar via a weld between the side of the busbar opposite the housing and the second straight section of each of the plurality of fingers.

11. The battery pack as recited in claim 1, wherein each of the plurality of fingers are spaced-apart from an adjacent one of the plurality of fingers by a gap.

12. The battery pack as recited in claim 11, wherein each of the gaps are of substantial equal width.

13. The battery pack as recited in claim 1, wherein each of the plurality of fingers projects through the slot.

14. The battery pack as recited in claim 1, wherein each of the plurality of fingers are formed by laser cutting the tab terminal.

15. The battery pack as recited in claim 1, wherein the tab terminal is a first tab terminal extending from the housing, and wherein the battery pack further comprises a second tab terminal extending from the housing in a third direction opposite the first direction, wherein the second tab terminal includes a plurality of fingers spaced-apart from one another in the second direction, and wherein each of the plurality of fingers is in direct contact with another busbar.

16. The battery pack as recited in claim 15, wherein the tab first tab terminal is made of one of copper and aluminum, and the second tab terminal is made of the other of copper or aluminum.

17. A method, comprising:
electrically connecting a tab terminal of a battery cell to a busbar by inserting the tab terminal through a slot in the busbar, bending each of a plurality of fingers of the tab terminal, and securing each of the fingers to the busbar.

18. The method as recited in claim 17, wherein the tab terminal extends from a housing of the battery cell in a first direction, and wherein the plurality of fingers are spaced-apart from one another in a second direction perpendicular to the first direction.

19. The method as recited in claim 18, wherein:
the tab terminal includes a base section adjacent a housing of the battery cell,
each of the plurality of fingers projects from the base section to a free end opposite the housing,
each of the plurality of fingers includes a first straight section between the base section and a bend, and
each of the plurality of fingers includes a second straight section between the bend and the free end.

20. The method as recited in claim 19, wherein:
each of the plurality of fingers is configured such that the second straight section is substantially parallel with a side of the busbar opposite the housing, and
each of the plurality of fingers is secured to the busbar via a weld between the side of the busbar opposite the housing and the second straight section of each of the plurality of fingers.
